(19) United States
(12) Patent Application Publication
(10) Pub. No.: US 2005/0286487 A1
(43) Pub. Date: Dec. 29, 2005

(54) Distributed routing of data flow

(75) Inventor: Prabhakar R. Chitrapu, Blue Bell, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/019,598

(22) Filed: Dec. 22, 2004

Related U.S. Application Data
(60) Provisional application No. 60/583,709, filed on Jun. 29, 2004.

(51) Int. Cl. H04L 12/28

(52) U.S. Cl. 370/351

(57) ABSTRACT

A data flow is divided into multiple sub-flows. At least two of the sub-flows are routed through separate paths through one or multiple networks, and the sub-flows are received and combined to reconstruct an estimate of the original data flow. The separate paths may be result by placing different routing information in the headers of the packets of different sub-flows, by routing by a router the packets of each sub-flow differently, using different channels for the sub-flows or using different within channel paths, such as multipaths.

### CROSS REFERENCE TO RELATED APPLICATION(S)

This application claims the benefit of U.S. provisional application No. 60/583,709 filed on Jun. 29, 2004, which is incorporated by reference as if fully set forth.

### FIELD OF INVENTION

This invention relates to data communications, and more particularly to data communication which are modified for transmission to prevent unauthorized reception of information contained within the transmission.

### BACKGROUND

As shown in FIG. 1, in a typical communication between two nodes 10 (at location A) and 12 (at location C), information exchanged is routed via a path through a transmission network 15. The path may be static, as in a public switched telephone network (PSTN), or dynamic as in Internet communications. In the example shown, the network 15 includes a wireless communication network 17, a WLAN network 18 and a PSTN 19. The wireless communication network 17 may be configured as a cellular network, and is depicted as including a base station 23, a network hub such as a Node B 24 and a radio network controller 25. The WLAN network 18 is depicted as including access points (APs) 27, 28. The WLAN network 18 may be controlled by the RNC 25 or independent of the RNC 25.

The path from A to B is established so as to establish the desired communication, for example through air link 29 to AP 27, and thence along network connections to B. Depending on the nature of the network 15 and the nature of data itself, the information along the route may be intercepted by a third party with varying degrees of difficulty. In order to prevent this, protection mechanisms such as encryption are typically employed. These measures require coordination between sender and recipient.

Regardless of the manner in which protection mechanisms, such as encryption, are employed, the raw data stream is often accessible. In wireless transmissions, an encrypted data stream is accessible to any individual with a wireless receiver in proximity to the wireless transmission. In wired systems, an individual with access to any point or segment of the wired path may be able to access the encrypted data stream. With sufficient decryption capabilities, the data stream may be decoded.

Accordingly, it is desirable to have alternate schemes for adding security to data communications.

### SUMMARY

A data flow is divided into multiple sub-flows. At least two of the sub-flows are routed through separate paths through one or multiple networks. The sub-flows are received and combined to reconstruct an estimate of the original data flow. The separate paths may result by placing different routing information in the headers of the packets of different sub-flows, by routing by a router the packets of each sub-flow differently, using different channels for the sub-flows or using different path within channel paths, such as multipaths.

### BRIEF DESCRIPTION OF THE DRAWINGS

FIG. 1 is an illustration of a typical data transfer between two nodes.

FIG. 2 is an illustration of distributed routing of a data flow over multiple paths.

FIG. 3 is an illustration of distributed routing of a data flow over multiple paths and over multiple transmission networks.

FIG. 4 is a flow diagram showing initiation of the inventive process in a call setup.

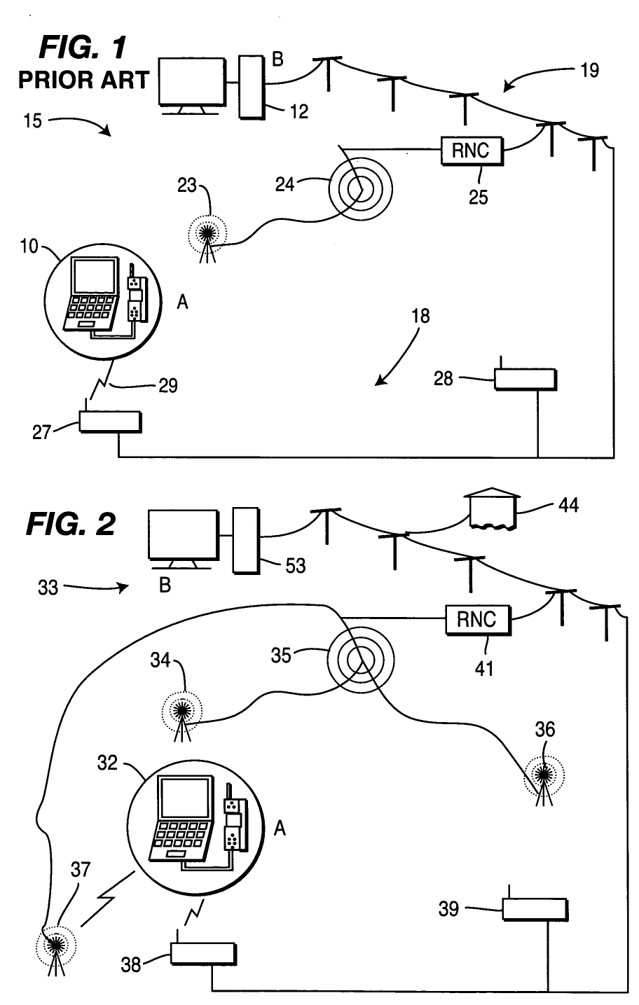

### DETAILED DESCRIPTION OF THE PREFERRED EMBODIMENTS

As used herein, the terminology “transmit/receive units” (TRUs) refers to both “wired transmit/receive units” and “wireless transmit/receive units” (WTRUs). A “wireless transmit/receive unit” (WTRU) includes but is not limited to a user equipment, mobile station, fixed or mobile subscriber unit, pager, or any other type of device capable of operating in a wireless environment. “Wired transmit/receive units” include any device capable in communicating in a wired communication network. The terminology “base station” includes but is not limited to a Node B, site controller, access point or any other type of interfacing device in a wireless environment.

It is advantageous to define different types of paths. For wireless connections, the separate paths may be separate wireless physical channels. Alternately, the separate paths may be within the same channel or a combination of intra and inter channel paths. An example of a within channel paths are multipath components. A wireless transmission may follow multiple paths to a destination. To distribute the sub-flows over different multipaths various approaches may be used. One approach is to use spatial diversity and to send each sub-flow over a different antenna element. Another approach is to use beam steering and to send each sub-flow in a separate beam. Another approach would be to place a time delay between the different sub-flow transmissions to create an artificial multipath. Other techniques may be used as well. The wireless connections may be between base stations and WTRUs or between WTRUs or both.

It is possible to distinguish between at least three types of paths:
1) Internet paths,
2) multi-network paths, and
3) radio paths.

An Internet path may be characterized by a sequence of IP-addresses, each of which denotes a routing device. A set of multi-network paths consist of a combination of two or more paths, each of which is a path in a different network. By way of example, one network can be WLAN and another cellular network. Such paths are suitable for dual/multi mode terminals.

Radio paths can take various forms. One can define a path in terms of a code or frequency or timeslot or some time varying combination of these. General usage of such paths is known; e.g., multi-code transmission for increased data rate. Radio paths may also be defined in terms of different physical paths. By way of example, if a signal can travel from a WTRU to another WTRU along multiple radio paths, each of these would be defined as a radio path. This is similar to space division multiple access (SDMA); however, spatial separation in SDMA is used to multiplex different users. According to the present invention, the multiple radio paths are used for splitting the data from a single user for security purposes.

The use of multiple radio paths also has the advantages of improving the signal by increasing error-robustness and may also be used to increase the data rate. Additionally, the use of multipath techniques and the use of spatial separation increases increasing data rate.

In an ad hoc network, the separate paths may be routed through different access points (APs) or base stations and WTRUs. To illustrate, one path may be from an access point to a destination WTRU and another path from a transmitting WTRU to the destination WTRU. In a cellular environment, the separate paths may be routed through different base stations.

FIG. 2 is an illustration of an embodiment of distributed data flow routing. Data (data flow) from a first node 32, at location A, is processed to flow in two data paths in a network environment. The network includes cellular wireless network elements 34-37, access points 38-39, a radio network controller 41, a PSTN 44 and a node 53. Data is communicated through multiple paths through the network. The data may already be encrypted or may be unencrypted. The data flow is split into multiple sub-flows. The splitting of the data flows may be performed in several different schemes. One scheme would split the data to minimize the chance of recovering the data if not all the sub-flows are recovered. The separation of data is performed so that an interceptor with the correct keys would not be able to decode the data stream along a single or sub-set of the paths. Alternately, the separation may be performed to facilitate error correction at the receiving node (such as node 53, at location B,). Even if the receiving node 53 does not receive all of the paths, it may still be capable of reconstructing the data only using the received paths.

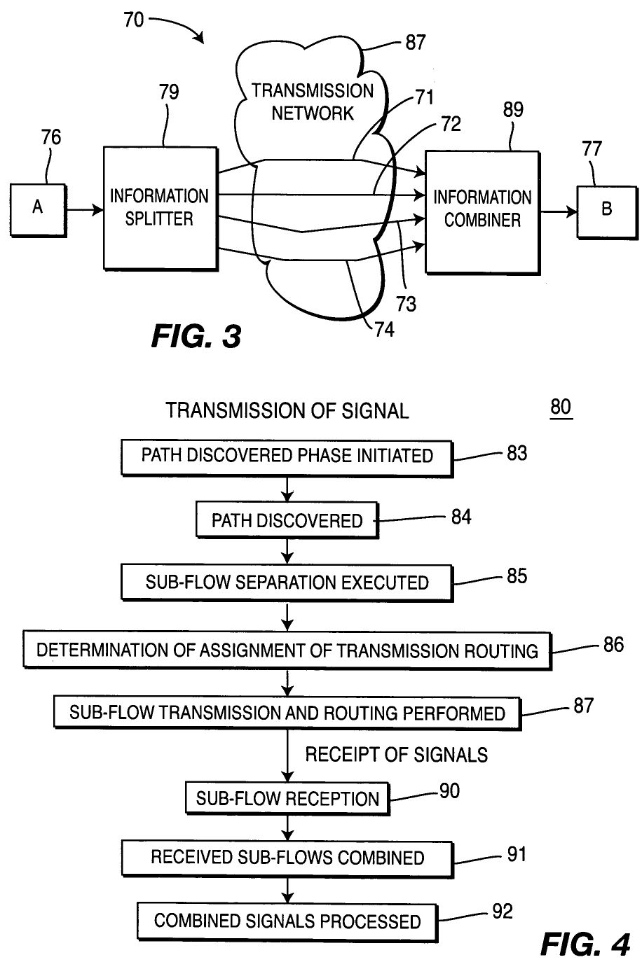

FIG. 3 is a representation of a transmission network 70 in which the information flow divided into sub-flows 71-74. A first node 76 at location A directs information to a second node 77. The data is split at an information splitter 79, transmitted through a transmission network 87 to an information combiner which provides the information to node 77. The splitter 79 and combiner 89 may be part of their respective nodes 76, 77 or may be at separate locations within the data flow. Each sub-flow 71-74 is sent to the second node 77, at location B, over a respective path in the transmission network 70. The transmission network 70 may be a wired, wireless or a hybrid wired/wireless network. Examples of such networks include public switched telephone networks (PTSNs) and public land mobile networks (PLMNs), the Internet, among many others. The information combiner 89 receives each sub-flow over each path 71-74. The information combiner 89 combines the sub-flows into the original data flow for use by node 77, at location B. Although the data transfer is shown flowing in one direction from node 76 to node 77, it is also possible for the data to in both directions, from node 76 to node 77 and from node 77 to node 76. For bi-directional communication, only one direction may use multiple paths or both directions may use multiple paths. Additionally, the distinct paths may be bi-directional. After receipt by node 77, the data flow may be used at that node or sent to a subsequent node.

Typically, at least one of the nodes 76, 77 would be a TRU. The TRU may also comprise the information splitter 78 and/or information combiner 89 or the information splitter 79 and/or information combiner 89 may be separate from the TRU, such as within the transmission network 70 or an external device.

The routing of the sub-flows into separate paths 71-74 may be initiated by a TRU. The TRU may also route the sub-flows through different paths, such as by placing different routing information into headers of packets of the different sub-flows. Alternately, the routing may be initiated within the network. To illustrate, a router within the network may route the sub-flows through different paths.

An interceptor without access to the multiple networks 71-74 would have to try to decode the data without all of the sub-flows. The interceptor would be left with incomplete data or undecipherable data. Without all of the sub-flows, even with the correct deciphering keys, the data may be undecipherable.

The use of multiple networks may be initiated by a dual mode TRU. To illustrate, a wireless TRU may be capable of using a wireless local area network (WLAN) or cellular network. The distribution of the paths 71-74 through the multiple networks reduces the possibility of interception. The TRU may also route the sub-flows through different networks, such as by placing different routing information into headers of packets of the different sub-flows. Applied to the configuration of FIG. 2, one sub-flow would incorporate base station 37, and a second sub-flow would incorporate AP 38. Further sub-flows would perhaps use these same links but continue with different routings.

Alternately, the use of multiple networks may be initiated within the network. To illustrate, a PLMN may route some paths through itself and a PSTN network.

FIG. 4 is a flow diagram showing initiation of the inventive process in a call setup 80. A path discovery phase is initiated (step 83). After paths are discovered (step 84), sub-flow separation is executed (step 85). Once a sub-flow separation is achieved a determination is made (step 86) on assignment of transmission routing and the sub-flows transmission and routing (step 87) is performed. Receipt of the signals include sub-flow reception (step 90), combining of the received sub-flows (step 91) and processing of the combined signals (step 92). While the steps are described in terms of separation and routing of the sub-flows by the transmitting TRU, it is possible to cause the division of the sub-flows from the receiving TRU. Alternatively, the receiving TRU may re-initiate the communication and thereby establish multiple sub-flows from the other corresponding TRU.

Path discovery could be different in the three different types of paths identified earlier. In the case of radio paths, it is possible to probe to locate available radio paths.

In the case of UDP communications, the communications may be unacknowledged. This would be the case with UDP like IP-packet flows. If TCP is used, then each packet may be acknowledged per sub-flow. It is also possible that packets arrive with different delays along different paths. If the delay is significant from a signal processing standpoint, it is possible to provide buffering before or during the combining process at the receiver.

One embodiment of the invention can be implemented in the context of mesh/peer-to-peer/ad-hoc networks. Assume that a TRU is one of the nodes. That node can first discover the number of connections/communication-links it has. Depending on this, the TRU can transmit appropriate amount of data. As a result, an additional data link is established, which has the advantages of increasing data throughput capacity or data bandwidth, and also enhancing data security. This increases the richness or denseness of the connectivity, which results in an increase data transfer rate.

Although the features and elements of the present invention are described in the preferred embodiments in particular combinations, each feature or element can be used alone (without the other features and elements of the preferred embodiments) or in various combinations with or without other features and elements of the present invention.

1. A method of transferring a data flow between a first and second node, the method comprising:
providing a data flow at the first node;
separating the data flow into a plurality of sub-flows;
intentionally routing packets of at least two of sub-flows along different paths;
after routing over the different paths, receiving the plurality of sub-flows at the second node; and
combining the sub-flows into an estimate of the data flow.

2. The method of claim 1 comprising the intentional routing performed by a transmit/receive unit of the first node.

3. The method of claim 2 wherein the transmit/receive unit routes over different paths by inserting different routing information in a header of packets of the at least two sub-flows.

4. The method of claim 1 comprising the intentional routing performed by a router of a network.

5. The method of claim 1 comprising the different paths at least partially distinguished by different physical wireless channels.

6. The method of claim 1 comprising the different paths at least partially distinguished by different multipaths of a same physical wireless channel.

7. The method of claim 1 comprising the different paths at least partially distinguished by different wireless transmission sources.

8. The method of claim 1 comprising the different paths at least partially distinguished by passing through different networks.

9. The method of claim 1 comprising the different paths at least partially distinguished by different PSTN channels.

10. The method of claim 1 comprising the different paths at least partially distinguished by different routes through the Internet.

11. The method of claim 1 further comprising the second node transferring the estimated data flow to a third node.

12. The method of claim 1 comprising at least one of the plural paths provided as a bidirectional path and data transferred bi-directionally over said path.

13. A method of transferring a data flow between a first and second node, the method comprising:
providing a data flow at the first node;
separating the data flow into a plurality of sub-flows; and
intentionally routing packets of at least two of sub-flows along different paths to a second node.

14. A method of transferring a data flow between a first and second node, the method comprising:
receiving packets of a data flow separated into at least two sub-flows over at least two different paths, the packets of each sub-flow following a respective one of the two different paths; and
combining the sub-flows into an estimate of the data flow.

15. A method of transferring data in a communication link with a transmit/receive unit, the method comprising:
receiving a request for communication;
initiating a path discovery process for the requested communication; and
in the case of availability of plural paths suitable for the communication, determining an assignment or transmission routing utilizing at least a subset of the plural paths.

16. The method of claim 15, further comprising:
separating the data flow into a plurality of sub-flows;
intentionally routing packets of at least two of sub-flows along different paths; and
after routing over the different paths, receiving the plurality of sub-flows and combining the sub-flows.

17. The method of claim 15 comprising the initiating the path discovery process performed by a transmit/receive unit.

18. The method of claim 17 wherein the transmit/receive unit routes over plural paths by inserting different routing information in a header of packets of the subset of the plural paths.

19. The method of claim 15 comprising the initiating the path discovery process performed by a router of a network.

20. The method of claim 15 comprising the plural paths at least partially distinguished by different physical wireless channels.

21. The method of claim 15 comprising the plural paths at least partially distinguished by different multipaths of a same physical wireless channel.

22. The method of claim 15 wherein the plural paths are at least partially distinguished by different wireless transmission sources.

23. The method of claim 15 comprising the plural paths at least partially distinguished by passing through different networks.

24. The method of claim 15 comprising the plural paths at least partially distinguished by different PSTN channels.

25. The method of claim 15 comprising the plural paths at least partially distinguished by different routes through the Internet.

26. The method of claim 15 further comprising the second node transferring the estimated data flow to a third node.

27. The method of claim 15 comprising at least one of the plural paths provided as a bi-directional path and data transferred bi-directionally over said path.

28. A transmit/receive unit capable of transferring a data flow in a secure manner, the transmit/receive unit comprising:
a circuit configured for establishing a communication data flow over plural data links;
a circuit configured for separating the data flow of the communication into a plurality of sub-flows; and
a circuit configured for intentionally routing packets of at least two of sub-flows along different paths.

29. The transmit/receive unit of claim 28, comprising the transmit/receive unit configured as a wireless transmit/receive unit (WTRU) and effecting wireless communications over at least portions of the data links terminating with the transmit/receive unit.

30. The transmit/receive unit of claim 28, further comprising:
a circuit for receiving a communication in a plurality of sub-flows; and
a circuit for combining the sub-flows into an estimate of the data flow.

31. The transmit/receive unit of claim 28 comprising the different paths at least partially distinguished by different physical wireless channels.

32. The transmit/receive unit of claim 28 wherein the transmit/receive unit routes over different paths by inserting different routing information in a header of packets of the at least two sub-flows.

33. The transmit/receive unit of claim 28 comprising the intentional routing performed by a router of a network.

34. The transmit/receive unit of claim 28 comprising the different paths at least partially distinguished by different multipaths of a same physical wireless channel.

35. The transmit/receive unit of claim 28 comprising the different paths at least partially distinguished by different wireless transmission sources.

36. The transmit/receive unit of claim 28 comprising the different paths at least partially distinguished by passing through different networks.

37. The transmit/receive unit of claim 28 comprising the different paths at least partially distinguished by different PSTN channels.

38. The transmit/receive unit of claim 28 comprising the different paths at least partially distinguished by different routes through the Internet.

39. The transmit/receive unit of claim 28 further comprising the second node transferring the estimated data flow to a third node.

40. The transmit/receive unit of claim 28 comprising at least one of the plural paths provided as a bi-directional path and data transferred bi-directionally over said path.
